(19) United States
(12) Patent Application Publication
(10) Pub. No.: US 2015/0004573 A1
(43) Pub. Date: Jan. 1, 2015

(54) Onboard Operator Coaching System with Show Me Feature

(71) Applicant: Caterpillar Inc., Peoria, IL (US)

(72) Inventors: Bradley Bomer, Perkin, IL (US); Zhijun Cai, Springfield, IL (US); Brad Van De Veer, Washington, IL (US); Jeffrey Stephen Alig, Metamora, IL (US); Michael Braunstein, Washington, IL (US)

(21) Appl. No.: 13/927,346

(22) Filed: Jun. 26, 2013

(51) Int. Cl. G09B 5/04

(52) U.S. Cl. CPC G09B 5/04
USPC 434/219

(57) ABSTRACT

A method is provided for coaching an operator of an earthmoving machine having a controller. The method may include the controller presenting a list of coaching points to the operator. The controller receives input to execute a coaching point selected by the operator. The controller accesses memory to retrieve a predetermined method for execution of the coaching point. The controller manipulates the machine to execute the coaching point according to the predetermined method.

### FIELD OF THE DISCLOSURE

The present disclosure relates generally to earthmoving machines and, more particularly, to systems and methods for coaching an operator of an earthmoving machine.

### BACKGROUND OF THE DISCLOSURE

Machines used in earthmoving, industrial and agricultural applications require considerable skill to operate. Such machines include, but are not limited to, wheel loaders, tract-type tractors, motor graders, excavators, articulated trucks, pipe layers, backhoes, and the like. Operators of such machines must generally undergo extensive training in order to understand how to safely and efficiently operate the machine.

In addition, each machine may have an ideal or expected method of operation. The ideal method of operation may, for example, be designed to enable efficient or optimal performance of the machine. However, for a variety of reasons, an operator may deviate from the ideal operating method while using the machine. For example, the operator may have limited skills, may encounter an unusual and/or challenging work environment, or may simply be fatigued. In any event, such a failure to follow the expected operating method may lower machine performance, reduce fuel efficiency, or cause other undesirable effects. Furthermore, earth-moving machines typically only have one seat in the cab, thereby making side-by-side training with both the operator and a trainer unfeasible.

One solution has been to create a system which generates a simulated environment of a worksite. For example, U.S. Pat. No. 8,139,108, entitled “Simulation System Implementing Real-Time Machine Data” and assigned to Caterpillar Inc., describes such a system. The system of the '108 patent describes a simulation system that uses real-time performance data to remotely simulate operation of a machine at a worksite. Once a controller of the system of the '108 patent generates a simulated 3-D environment of the worksite, the operator can control and move the machine about the worksite.

The present disclosure is directed to a system to improve operator skill levels. However, it should be appreciated that the solution of any particular problem is not a limitation on the scope of this disclosure or of the attached claims except to the extent expressly noted. Additionally, this background section discusses problems and solutions noted by the inventors; the inclusion of any problem or solution in this section is not an indication that the problem or solution represents known prior art except that that the contents of the indicated patent represent a publication. With respect to the identified patent, the foregoing summary thereof is not intended to alter or supplement the prior art document itself; any discrepancy or difference should be resolved by reference to the document itself.

### SUMMARY OF THE DISCLOSURE

In accordance with one aspect of the present disclosure, a method is provided for coaching an operator of an earthmoving machine having a controller. The method may comprise the controller presenting a list of coaching points to the operator. The controller receives input to execute a coaching point selected by the operator. The controller accesses memory to retrieve a predetermined method for execution of the coaching point. The controller manipulates the machine to execute the coaching point according to the predetermined method.

In accordance with yet another aspect of the present disclosure, a non-transitory computer readable storage medium having stored thereon computer-executable instructions which when executed by a computer cause the coaching of an operator of an earthmoving machine. The computer-executable instructions, in this aspect, comprise instructions for determining a type of operation being performed by the machine, instructions for presenting a list of coaching points based on the type of operation being performed, receiving input from the operator to execute a coaching point, instructions for accessing memory to retrieve a predetermined method for executing the coaching point, and instructions for controlling the machine to execute the coaching point according to the predetermined method.

In accordance with another aspect of the present disclosure, a system is provided for coaching an operator of an earthmoving machine. In accordance with this aspect, the system includes an actuator of the machine, an operator input/output device, and a controller operatively connected to the operator input/output device and the actuator. The controller is configured in this embodiment to provide a coaching point to the operator, receive input from the operator via the operator input/output device to execute the coaching point, access memory to retrieve a predetermined method for executing the coaching point, and send signals to the actuator according to the predetermined method for executing the coaching point.

These and other aspects and features will become more readily apparent upon reading the following detailed description when taken in conjunction with the accompanying drawings.

Although various features are disclosed in relation to specific exemplary embodiments, it is understood that the various features may be combined with each other, or used alone, with any of the various exemplary embodiments without departing from the scope of the disclosure.

### BRIEF DESCRIPTION OF THE DRAWINGS

FIG. 1 is a perspective view of a machine according to an example embodiment of the present disclosure;

FIG. 2 is a block diagram of a system for coaching an operator according to another embodiment of the present disclosure;

FIG. 3 is a block diagram of a system for coaching an operator according to another exemplary embodiment of the present disclosure;

FIG. 4 is a block diagram of a system for coaching an operator according to another embodiment of the present disclosure;

FIG. 5 is a flowchart illustrating a method for coaching an operator of a machine according to another embodiment of the present disclosure; and

FIG. 6 is a perspective view of another machine according to another embodiment of the present disclosure.

While the present disclosure is susceptible to various modifications and alternative constructions, certain illustrative embodiments thereof will be shown and described below in detail. The disclosure is not limited to the specific embodiments disclosed, but instead includes all modifications, alternative constructions, and equivalents thereof.

### DETAILED DESCRIPTION

The present disclosure provides a system and method for coaching an operator of a machine. The disclosed system and method act to improve operator skill levels through autonomous demonstration of an operation by the machine. In particular, the operator may be seated within a cab of the machine at a training worksite and may select from a list of coaching points, an automated demonstration of one of the coaching points in order to observe an ideal operating method. Alternatively, the system can detect a type of operation being performed on the machine by the operator, and present to the operator a list of coaching points based on the type of operation being performed. The system determines which coaching points can be autonomously executed and presents such feature to the operator. The operator then decides whether to observe the automated demonstration of a particular coaching point or not.

When prompted to execute the coaching point, a controller of the system takes control of the machine and executes the coaching point according to the ideal operating method. The ideal operating method may be defined as a technique which enables an efficient or optimal performance of the machine. As used herein, the term “ideal” is not meant to refer to a universally recognized ideal, but rather to refer to a predetermined sequence of operations used as a template or example, whether or not such sequence is deemed to be more advantageous than one or more alternative sequences.

Reference will now be made in detail to specific embodiments or features, examples of which are illustrated in the accompanying drawings. Generally, corresponding reference numbers will be used throughout the drawings to refer to the same or corresponding parts.

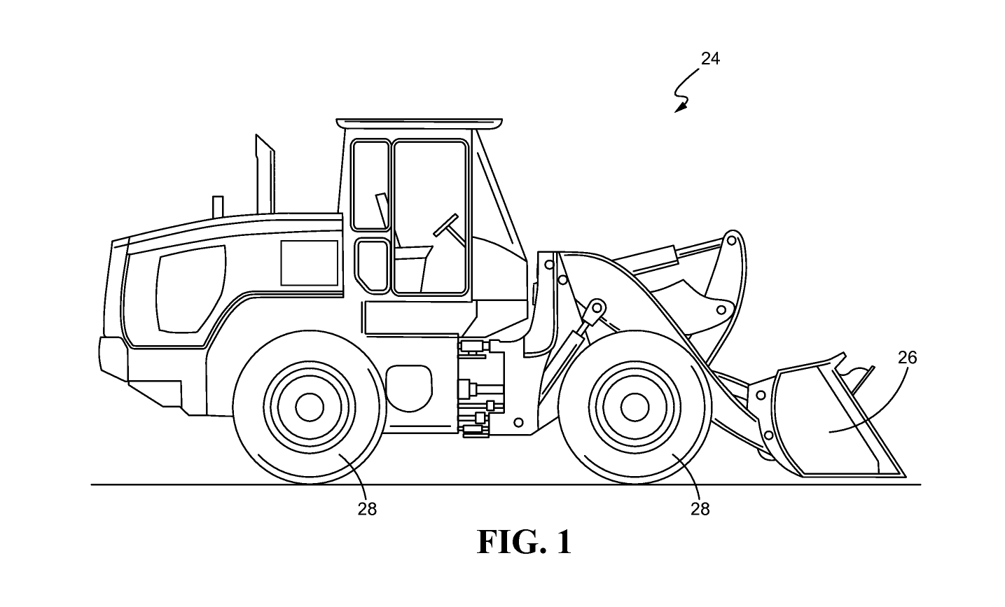

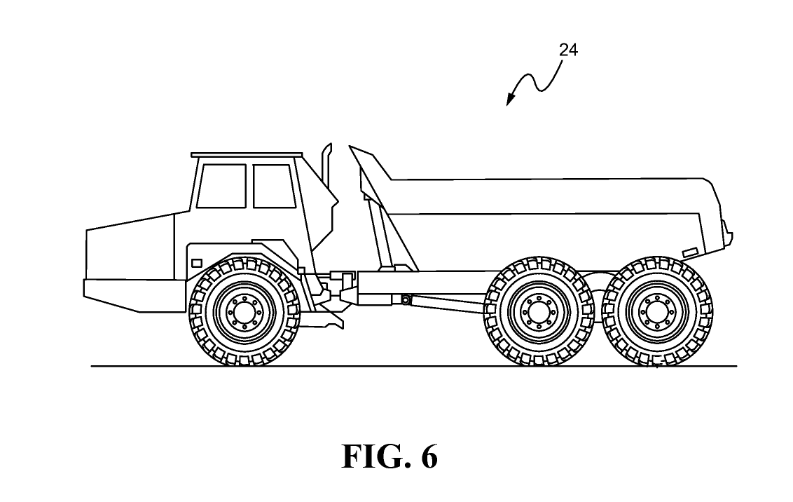

Turning now to FIGS. 1-6, although the machine 24, in FIG. 1, is shown to be a wheel loader, it will be understood that in other embodiments, the machine may be any other type of machine or vehicle used in earthmoving, industrial or agricultural applications. For example, the machine 24 may be, without limitation, an articulated truck (as shown in FIG. 6), an excavator, a tract-type tractor, a motor grader, a pipe layer, a backhoe, or the like. It is also to be understood that the machine 24 is shown primarily for illustrative purposes to assist in disclosing features of various embodiments, but that FIG. 1 does not depict all of the components of an exemplary machine.

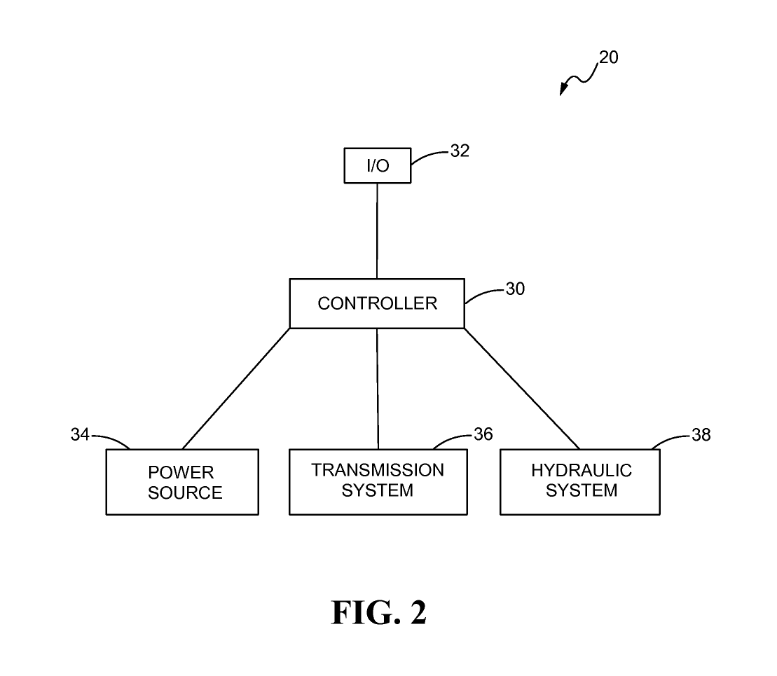

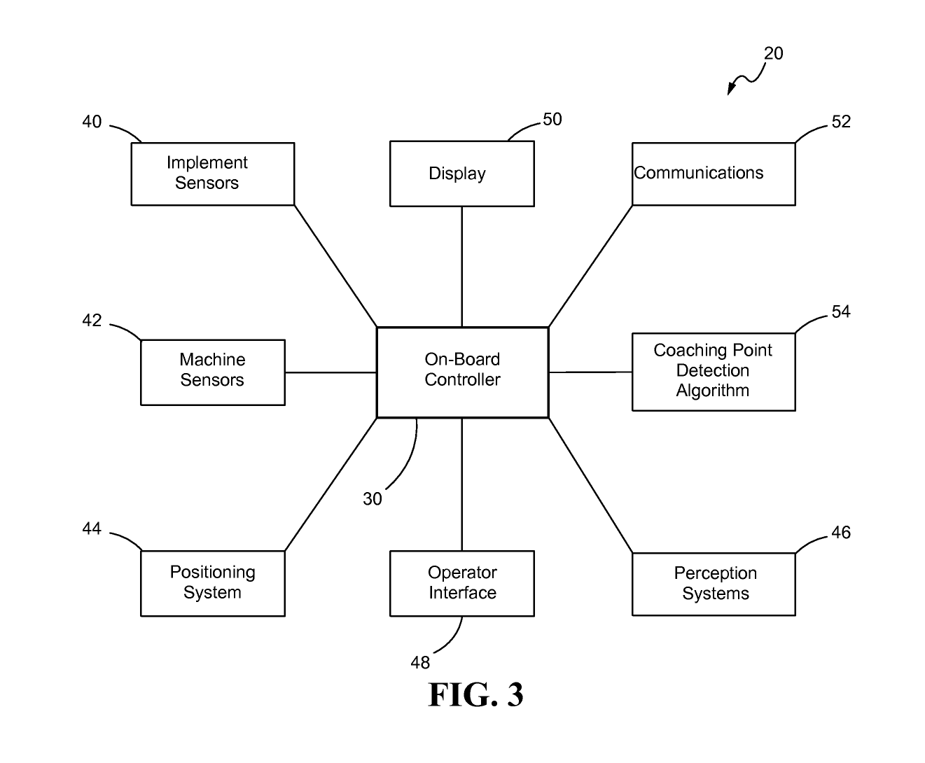

In an embodiment, the system 20 is integral to the machine 24. For example, as shown best in FIG. 2, the system 20 may comprise a controller 30 in communication with an input/output (I/O) device 32, power source 34, transmission system 36, and hydraulic system 38, all of which are part of the machine 24. As shown best in FIG. 3, the system 20 may further comprise implement sensors 40, machine sensors 42, a positioning system 44, perception systems 46, and communications system 52, in addition to the controller 30, input device or operator interface 48 and output device or display 50. The implement sensors 40 may comprise sensors configured to measure implement or tool position, load pressure, pin angle, actuator displacement, and the like. The machine sensors 42 may comprise sensors configured to measure machine speed, engine speed, transmission gear, steering angle, articulation angle, and the like.

The positioning system 44 may identify a current location, time or position of the machine 24 and may comprise a navigation system which uses the global positioning system (GPS), an inertial measurement unit (IMU), a dead reckoning procedure, perception-based localization (PBL), or a combination thereof. The system 20 may also comprise on-board and off-board perception systems 46, which may detect objects, personnel, or other machines close to the machine 24. The perception systems 46 may use radar, lidar, cameras, or a combination thereof for object and personnel detection. The communications system 52 may connect to off-board components, such as through antennas, Wi-Fi, and other wired or wireless communication devices. Information from other machines or personnel not onboard the machine 24 may be sent to the controller 30 of the machine 24 via the communications system 52. For example, other machines within a vicinity of the machine 24 (e.g., within a predetermined area or radius around the machine 24) may each have a positioning system determining a location of each machine; the controller 30 of the machine 24 may then receive the location of the other machines, via the communications system 52, sent from the other machines or from personnel not onboard the machines.

The controller 30 may comprise any non-transitory computer readable storage medium having stored thereon computer-executable instructions, such as, at least one processor, configured to manipulate the machine 24. Algorithms or sets of instructions for presenting a coaching point or a list of coaching points to the operator and executing a coaching point according to an ideal operating method are preprogrammed into a memory of the controller 30.

More specifically, the controller 30 is programmed to include a list of coaching points that the operator can access in order to receive coaching on the ideal operating methods of the machine 24. A coaching point is a specific action during an operation that can be performed in a certain manner in order to achieve an optimal performance of the machine 24. Expert operators and trainers may identify the coaching point based on common practices of novice operators who need coaching to perform the specific action in an efficient or safe manner. For example, one coaching point for the wheel loader may be no articulation during dig. Wheel loaders generally steer via articulation, which includes a pair of hydraulic cylinders connected between a front frame and a rear frame on opposing sides of an articulation point. Each cylinder may be selectively actuated (e.g., extended and retracted) to pivot the front frame with respect to the rear frame and steer the wheel loader. To achieve an efficient performance of the machine 24, it may be optimal for the machine 24 to enter the pile straight on, not articulated.

Other examples of coaching points for the wheel loader may be, without limitation, setting tires 28 of the wheel loader properly during digging, loading with lift and using bucket curl, proper bucket angle during dig, and loading the bucket 26 without using back and forth articulation. A list of all the various identified coaching points may be presented to the operator. For instance, the system 20 may have a glossary or section for helpful tips including the list of coaching points that the operator may access through I/O device 32. The I/O device 32 may include one or more joysticks, steering wheels, pedals, keyboards, touchscreens, displays, speakers, voice recognition software, microphones, or the like.

From the list of coaching points, there may be certain ones that can be autonomously executed, and those are predetermined and programmed as such into the memory of the controller 30, along with an ideal operating method for each. The preprogrammed ideal operating method includes commands to be sent by the controller 30 to other parts of the machine 24 for autonomous execution of the coaching point. In addition, coaching points may vary depending on the particular machine 24. For example, one coaching point for an articulated truck may be improper positioning of the articulated truck relative to a load location, while a coaching point for an excavator may be overextending a boom when swinging. Other coaching points are certainly possible.

When the operator accesses the list of coaching points and selects a coaching point, the controller 30 determines whether the selected coaching point can be autonomously executed, as preprogrammed in the memory of the controller 30. If the selected coaching point can be autonomously executed by the system 20, then the controller 30 presents such feature to the operator via I/O device 32. The operator may then choose to observe autonomous execution of the coaching point on the machine 24.

When the controller 30 receives input from the operator through the I/O device 32 prompting the system 20 to execute the selected coaching point, the controller 30 then accesses memory and provides commands to move at least one actuator of the machine 24 (e.g., the power source 34, transmission system 36, and hydraulic system 38) in accordance with the ideal operating method as preprogrammed in the memory. Instead of the operator manipulating the machine 24, the controller 30 may send signals to an electronic control module (ECM) of the hydraulic system 38, which then causes movement of linkages or implements, steering and/or articulation. The controller 30 may also send signals to the power source 34 and transmission system 36, such as to an engine ECM of the power source 34 and to a transmission ECM of the transmission system 36. The engine ECM and transmission ECM then cause the engine, transmission, gears, clutch, etc. of the machine 24 to move tracks, wheels, or the like and propel the machine 24 at a proper speed, acceleration, and direction.

For example, if the coaching point of no articulation during dig was selected by the operator, the controller 30 would then determine whether the coaching point could be autonomously executed. After accessing memory, if the controller 30 determined that the coaching point of no articulation during dig could be autonomously demonstrated on the machine 24 by the system 20, such feature would be presented to the operator, e.g., via a “show me” feature button on a display of the I/O device 32 or via a “show me” feature through audio selection over a speaker and microphone of the I/O device 32 having voice recognition software. If the operator chooses the “show me” feature, then the controller 30 accesses memory for the ideal operating method of the coaching point.

For the coaching point of no articulation during dig, the controller 30 sends signals to the ECM of the hydraulic system 38 to straighten the machine 24 such that there is no articulation angle between a front and rear of the machine 24. The articulation angle can be detected by machine sensors 42 (e.g., cylinder position sensor or articulation joint sensor) and sent to the controller 30 to ensure there is no articulation of the machine (e.g., articulation angle is zero degrees (0°)). The controller 30 may also detect a position of the machine 24 relative to a pile of material from data sent by the positioning system 44 and/or perception systems 46. For example, the controller 30 may access a site map stored in memory, which includes various terrain or geographic features (e.g., a position of the pile), and may compare a location of the machine to the site map in order to detect the position of the machine 24 relative to the pile. After determining the position of the machine 24 relative to the pile, the controller 30 then sends signals to the engine ECM and transmission ECM to propel the machine 24 directly or straight on to the pile for digging. In so doing, the system 20 autonomously demonstrates to the operator how to optimally approach the pile during dig without articulation. In addition, audio and/or visual instructions may be provided to the operator before, during, or after autonomous execution of the operation instructing him or her to steer the machine 24 straight on to the pile such that the articulation angle is zero degrees (0°) or between a predetermined range.

Another coaching point example for the wheel loader may be properly setting the tires 28 during dig. To achieve an efficient performance of the machine, it may be optimal to set the tires 28 by providing a high force on the tires 28 when digging. In order to autonomously execute this coaching point, the controller 30 may determine a location of the pile from data collected by the positioning system 44 and perception systems 46, and send signals to the engine ECM and transmission ECM to propel the machine 24 towards the pile. Based on data from the positioning system 44, perception systems 46, and machine sensors 42 (e.g., machine speed sensor or engine speed sensor), the controller 30 can determine when to lift the bucket 26 as it enters the pile (e.g., 0.5 seconds before the machine 24 enters the pile and stops) such that there is a high force on the tires 28, or a pressure spike or increase in pressure within a short amount of time in the bucket 26 to set the tires 28 during dig. The controller 30 also sends signals to the hydraulic ECM to lift the bucket 26 at an optimal magnitude (e.g., 30% to 50% of the lift linkage command strength) such that there is enough pressure in the bucket 26 to set the tires 28.

In another aspect, when a coaching point is selected for autonomous execution, the controller 30 may provide instructions to the operator for preparing the machine 24 for execution of the coaching point. The machine 24, a linkage or an implement of the machine 24 may need to be in a certain initial position or location before the system 20 can autonomously execute the coaching point. For instance, in the coaching point example of no articulation during dig, the controller 30 may instruct the operator to lower the bucket 26 of the machine 24 before execution of the coaching point. The controller 30 can have instructions programmed into its memory for directing the operator to maneuver the machine 24 into the initial position. The controller 30 sends signals to the I/O device 32 to output the instructions (e.g., through a visual display on a screen or audio description via speakers) to the operator. From data sent by implement sensors 40, machine sensors 42, positioning system 44, perception systems 46, and operator interface 48, the controller 30 can also detect whether the operator followed the instructions and provide further instructions based on the detected data.

According to another embodiment, the controller 30 may be programmed to detect a type of operation being performed on the machine 24 by the operator. Data sent to the controller 30 from the implement sensors 40, machine sensors 42, positioning system 44, perception systems 46, and operator interface 48 during the operation is used to determine the type of operation being performed. For example, from signals sent by the perception systems 46, the controller 30 can determine that the machine 24 is approaching a pile of material. From signals sent by the positioning system 44, the controller 30 can determine a GPS location of the machine 24 relative to the pile using positioning system 44. From signals sent by the operator interface 48, the controller 30 can determine commands to lift a linkage and the bucket 26. From signals sent by the implement sensors 40 (e.g., pressure sensor in the bucket 26), the controller 30 can determine that material is being loaded into the bucket 26; and from signals sent by the machine sensors 42, the controller can determine an engine speed and transmission gear. Based on a combination of this data, the controller 30 detects that the machine 24 is digging.

In addition, for each type of operation, there may be one or more associated coaching points programmed into the controller 30 with that type of operation. For example, if the wheel loader is digging, the coaching points of no articulation and proper bucket angle may be associated with digging. Therefore, when the controller 30 detects the type of operation being performed, it may present a list of the associated coaching points to the operator, as preprogrammed into the memory. As described above, the operator may choose to review an associated coaching point for coaching tips or help, and if applicable, may select the “show me” feature for an automated demonstration of the coaching point.

In another aspect, the controller 30 is also programmed to include a coaching point detection algorithm 54, which detects a coaching point during the determined type of operation. For every coaching point programmed into the controller 30, there may be a detection algorithm to detect when the coaching point occurs. Expected data for each coaching point, such as a predetermined set of parameters in accordance with an ideal operating method for the type of operation, may be included in the coaching point detection algorithm 54 preprogrammed into the memory associated with the controller 30. The controller 30 then compares actual data sent from the implement sensors 40, machine sensors 42, positioning system 44, perception systems 46, and operator interface 48 during the operation to the expected data for the type of operation being performed. If the actual data is not within (i.e., outside of) the expected data, the controller 30 detects that the operator did not perform the coaching point according to the ideal operating method.

For instance, with the coaching point example of no articulation during dig, when the controller 30 determines that the machine 24 is digging (as described above), the coaching point detection algorithm 54 monitors the articulation angle of the machine 24. The articulation angle of the machine 24 may be detected by the machine sensors 36 (e.g., cylinder position sensor or articulation joint sensor) and sent to the controller 30. The coaching point detection algorithm 54 then compares the detected or actual articulation angle to expected data for the articulation angle while digging. For example, since it may be optimal for the machine 24 to enter the pile straight on, the expected data for the articulation angle while digging may be less than fourteen degrees (14°) and greater than negative fourteen degrees (−14°) according to an ideal operating method for the machine 24. Other values for the expected data parameters for the articulation angle are certainly possible. If the actual articulation angle is outside the expected data, e.g., greater than fourteen degrees (14°) or less than negative fourteen degrees (−14°), then the operator did not perform according to the ideal operating method.

If the actual data is not within the expected data, the controller 30 may then present the “show me” feature for the detected coaching point to the operator (if applicable, as preprogrammed into the memory associated with the controller 30). The operator can then choose to observe an automated demonstration of the coaching point showcasing the ideal operating method. According to another aspect, the “show me” feature may include an automated demonstration of the actual action in accordance with the actual data or an automated demonstration of a non-ideal operating method preprogrammed into the memory associated with the controller 30. The controller 30 may then demonstrate the actual action or non-ideal method before demonstrating the ideal operating method. In so doing, the operator can compare his actual action (or the non-ideal operating method) to the ideal operating method and observe differences between the two. Audio description may be provided to the operator together with the automated demonstrations of the actual action (or the non-ideal operating method) and the ideal operating method in order to describe to the operator the differences between the two.

For instance, in the coaching point example of no articulation during dig, the controller 30 may autonomously demonstrate approaching the pile and digging at an articulation angle outside the expected data, e.g., greater than fourteen degrees (14°) or less than negative fourteen degrees (−14°), while providing audio description to the operator regarding the non-conforming articulation angle. The controller 30 may then autonomously demonstrate approaching the pile and digging at an articulation angle within the expected data, e.g., less than fourteen degrees (14°) and greater than negative fourteen degrees (−14°), while providing audio description to the operator regarding the expected (or ideal) articulation angle. In so doing, the operator can observe both demonstrations while on-board the machine and learn accordingly.

In addition, if the actual data is outside of the expected data, the controller 30 flags the coaching point, such as a coachable action needing improvement. Throughout the duration of the operator's training session, the controller 30 can flag multiple coaching points and store the flagged coaching points in the memory of the controller 30, along with a number of times each coaching point was flagged (e.g., the operator approached a pile with the machine 24 articulated five times). At an end of the training session or when the engine of the machine 24 is idle, the controller 30 may present a list of the flagged coaching points, as well as a number of occurrence for each, to the operator, who can then choose to review each coaching point and select the “show me” feature for an automated demonstration, if applicable. The operator then has the opportunity to observe the ideal operating method for the flagged coaching point, while still onboard the machine 24. Furthermore, the list of flagged coaching point and number of occurrence for each can be sent to an off-board component, such as to a display in a manager's office via communications system 52, for the manager of the operator to review the operator's performance.

In another aspect, the system 20 may be configured to provide audio description or audio instructions for playback to the operator, before, during or after autonomous execution of a coaching point. The audio description may describe in detail to the operator specific actions (e.g., proper action sequence, position, no articulation, etc.) of the ideal operating method for executing the coaching point. For example, the I/O device 32 may include a speaker, and the audio description may be saved or programmed into the memory of the controller 30. When prompted to execute the “show me” feature, the system 20 may execute the coaching point together with generating audio description of the operation through the speaker. The audio description may be synchronized with a real-time execution by the machine 24 of the specifically described actions. In addition, the audio description may be provided before or after autonomous execution of the coaching point as well.

When prompted to autonomously execute the coaching point, the system 20 may also be configured to disable further input from operator controls to avoid interference with the execution of the operation. Alternatively, during autonomous execution of the coaching point, when the system 20 receives any input from the operator, the receipt of operator input may cause the controller to cease the automated demonstration. The operator input may take precedence over the controller-provided commands to the machine 24, and the operator may regain control over the machine 24 from the system 20. There may also be an emergency stop feature in the system 20, which suspends controller execution of the coaching point. For example, upon receiving input signaling an emergency stop from the operator, the controller 30 may discontinue execution of the programmed ideal operating method, as well as halt movement of any part of the machine 24. The operator may then reacquire control of the machine 24 from the system 20.

Before and during autonomous execution of the coaching point, the system 20 may be configured to analyze safety conditions such as, including but not limited to, machine positioning and environmental conditions. Data collected from the implement sensors 40, machine sensors 42, positioning system 44, perception systems 46, operator interface 48, and communications system 52, is sent to the controller 30, which then analyzes the data to ascertain particular environmental and machine conditions, such as machine stability, ground inclination, machine park brake condition, machine location, machine positioning, location of other machines, and object and person detection. The controller 30 then determines whether to proceed with the automated demonstration based on the data. For example, based on machine position relative to objects, persons, or other machines, the controller 30 may verify a safe or unsafe condition. If a safe condition is verified, e.g., no other machines or persons are detected within a vicinity of the machine 24 (e.g., a predetermined area or radius around the machine 24), the controller 30 may proceed with providing commands for the automated demonstration. If an unsafe condition is detected, the controller 30 may stop the automated demonstration. The controller 30 may then proceed with autonomous execution of the coaching point when conditions are determined to be safe again or upon receiving input from the operator.

In another example, based on a GPS location of the machine 24 collected by the positioning system 44, the system can detect whether the machine 24 is within a designated or predetermined training area. If the machine 24 is located within the designated training area, the controller 30 may proceed with providing commands for the automated demonstration. If the machine 24 is not within the designated training area, the system 20, or controller 30, may prohibit certain operations. A further safety aspect of the system 20 may require input from a manager of the operator into the controller 30 (e.g., via communications system 52) in order to approve the autonomous execution of coaching points.

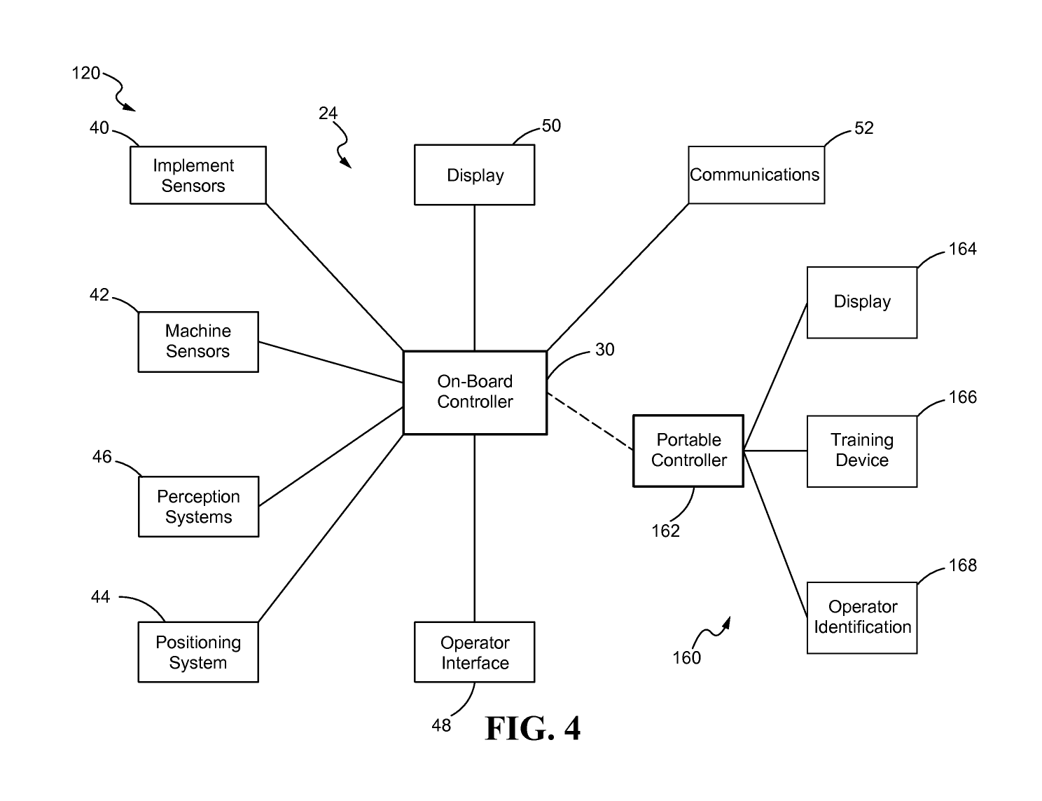

Referring now to FIG. 4, according to another embodiment of the present disclosure, the system 120 may comprise a portable apparatus 160 that is not integral to the machine 24. The portable apparatus 160 may be configured to manipulate the machine 24 in order to execute operations according to the ideal operating methods. The portable apparatus 160 may include a controller 162 in communication with an I/O device 164 (i.e., display), a training device 166 containing the coaching point detection algorithm, and an operator identification device 168 for the operator to identify himself and to allow the tracking of individual progress.

The controller 162 of the portable apparatus 160 may be operatively configured to communicate with the controller 30 of the machine 24. Algorithms or sets of instructions for executing operations according to the ideal operating methods, as well as a coaching point detection algorithm, may be preprogrammed into a memory of the controller 162 of the portable apparatus 160. Thus, when connected to the machine 24, the controller 162 of the portable apparatus 160 may provide commands to the controller 30 of the machine 24, as well as other parts of the machine, in order to present a coaching point to the operator and autonomously perform the coaching point according to the ideal operating method. In addition, the audio description, emergency stop, safety, and other features described above with regard to the system 20 and controller 30 may also be incorporated into the portable apparatus 160 and controller 162.

### INDUSTRIAL APPLICABILITY

In general, the foregoing disclosure finds utility in various industrial applications, such as in earthmoving, industrial, construction and agricultural machines. In particular, the disclosed operator coaching system and method may be applied to excavators, wheel loaders, tract-type tractors, motor graders, articulated trucks, pipe layers, backhoes, and the like. By applying the disclosed system and method to a machine, autonomous execution of operations by the machine may be achieved. Furthermore, the disclosed operator coaching system and method provide for on-board (i.e., on-machine) demonstration of ideal operating methods. In so doing, the operator can learn how to operate the machine in accordance with techniques which enable the efficient or optimal performance of the machine, e.g., with respect to fuel efficiency, operator efficiency, machine longevity, or other parameters that the operator wishes to optimize. Thus, by improving operator skill level, such aspects as machine performance and fuel efficiency may be improved.

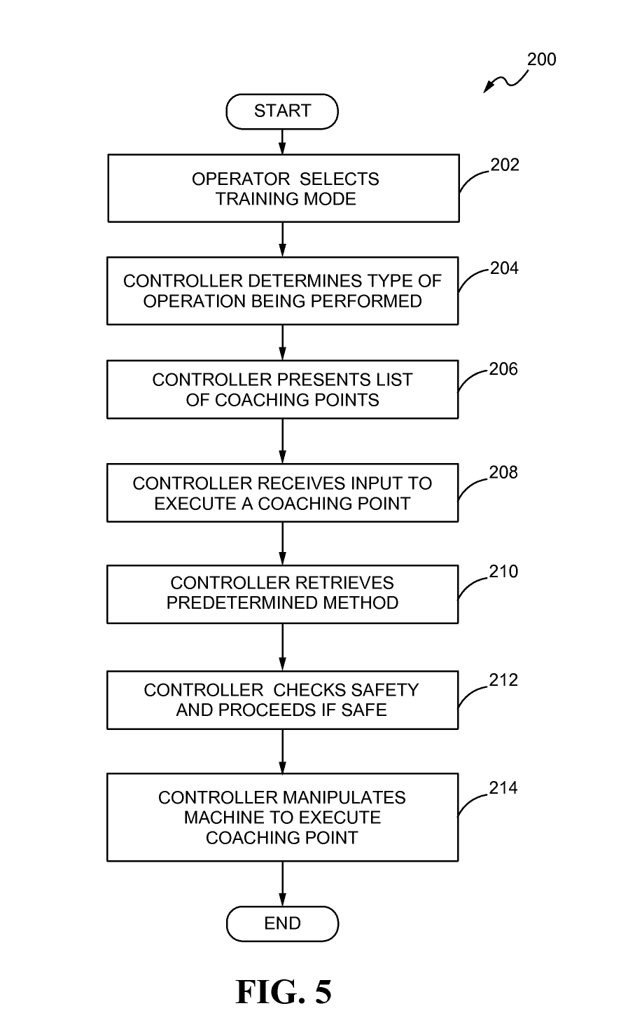

Turning now to FIG. 5, a flowchart outlining the method 200 for coaching the operator of the machine is shown, according to another embodiment of the present disclosure. The machine includes the controller. At a first step 202 of the method 200, the operator selects input (via the I/O device) to put the machine in a training mode. When the controller receives input to enable the training mode, the controller starts monitoring the operator's performance. At a next step 204, the controller determines the type of operation being performed on the machine by the operator. At a next step 206, the controller presents a list of coaching points to the operator based on the type of operation being performed. Next, at a step 208, the controller receives input from the operator (via the operator interface) to execute the coaching point.

Next, at a step 210, the controller accesses memory and retrieves a predetermined method (e.g., ideal operating method) for executing the coaching point. At a step 212, the controller may perform a safety check, analyzing data to ascertain particular environmental and machine conditions. If the controller determines a safe condition, then the controller may proceed with the autonomous execution of the coaching point. Lastly, at a step 214, the controller manipulates the machine to execute the coaching point according to the predetermined method, as preprogrammed into the controller.

In another example where the machine is an articulated truck, as shown in FIG. 6, at the first step 202, the operator selects to go into training mode on the machine. At the next step 204, the controller determines the type of operation being performed, such as carrying and dumping a payload. For example, from signals sent by the implement sensors (e.g., payload weight sensor in the dump body), the controller can determine there is a payload in the dump body. From signals sent by the operator interface, the controller can determine commands to reverse the truck, stop the truck, and lift the dump body. From signals sent by the machine sensors, the controller can determine an engine speed and transmission gear. From signals sent by the perception systems, the controller can detect the dump location (e.g., a cliff or wall of the dump location). From signals sent by the positioning system, the controller can determine a GPS location of the truck relative to the dump location. Based on a combination of this data, the controller detects that the truck is carrying and dumping the payload onto the dump location.

At the next step 206, once the controller determines that the dump truck is carrying and dumping the payload onto the dump location, the controller presents a list of coaching points related to this type of operation, as preprogrammed into the memory associated with the controller. One example coaching point the controller can present in the list when carrying and dumping the payload is proper positioning of the truck relative to the dump location. Furthermore, a “show me” feature may be presented to the operator with the coaching point of proper positioning of the truck relative to the dump location. Next, at the step 208, the controller receives input to execute the coaching point, e.g., the operator selects the “show me” feature through the operator interface. At the next step 210, the controller accesses memory and retrieves the predetermined or ideal operating method preprogrammed into the memory for the coaching point of proper positioning of the truck relative to the dump location. Next, at the step 212, the controller checks safety, such as determining that there are no objects, personnel, or other machines in between the back of the truck and the dump location via data sent to the controller by the perception systems. If there are no obstructions between the back of the truck and the dump location, then the conditions are safe to proceed with the automated demonstration.

Lastly, at the step 214, the controller manipulates the truck to execute the coaching point according to the ideal operating method. Before autonomous execution, the controller may provide instructions to the operator to prepare for execution of the coaching point, such as situating the truck in an initial position. For example, the controller may instruct the operator to position the truck in front of the dump location with the rear end of the truck facing a cliff or wall of the dump location. The controller then sends signals to the engine ECM and transmission ECM to propel the truck in reverse toward the dump location. Using data sent by the positioning system, the controller can determine when a back edge of the truck is at an optimal distance from the wall of the dump location (e.g., about five to eight meters (5-8 m) between the truck's back edge and the dump location wall). Upon reaching the optimal distance, the controller sends signals to the engine ECM and transmission ECM to stop and park the truck, thereby properly positioning the truck relative to the dump location. (The controller can also proceed to send signals to the hydraulic ECM to lift the dump body and dump the material onto the dump location.)

It will be understood that the flowchart in FIG. 5 is shown and described for example purposes only to assist in disclosing the features of the system and that more or fewer steps in a same or different order than shown may be included in the method 200 corresponding to the various features described above for the system without departing from the scope of the present disclosure.

Other innovative coaching and training features are also disclosed. For example, audio description of the ideal operating method may be delivered in synchronization with the real-time demonstration of that method by the machine. In so doing, operators can simultaneously see and hear how to skillfully operate the machine to its full efficiency, thereby providing an enhanced learning experience. The disclosed system and method also includes various sensors, a positioning system, and perceptions systems in order to enable safety checks of the environment before and during autonomous execution of the coaching points, thereby preventing damage to objects, personnel, or other machines in the vicinity.

While the foregoing detailed description has been given and provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims appended hereto.

While some features are described in conjunction with certain specific embodiments, these features are not limited to use with only the embodiment with which they are described, but instead may be used together with or separate from, other features disclosed in conjunction with alternate embodiments.

What is claimed is:

1. A method for coaching an operator of an earthmoving machine having a controller, the method comprising:
the controller presenting a list of coaching points to the operator;
the controller receiving input to execute a coaching point selected by the operator;
the controller accessing memory to retrieve a predetermined method for execution of the coaching point; and
the controller manipulating the machine to execute the coaching point according to the predetermined method.

2. The method of claim 1, further comprising the controller receiving actual data during an operation of the machine performed by the operator, and the controller determining a type of operation being performed based on the actual data.

3. The method of claim 2, further comprising the controller generating the list of coaching points based on the type of operation being performed.

4. The method of claim 2, further comprising the controller comparing the actual data to expected data for the type of operation being performed, the controller detecting a coaching point based on the comparison of actual data to expected data, and the controller presenting the list of coaching points based on the detection of a coaching point.

5. The method of claim 1, further comprising the controller providing audio description of the coaching point.

6. The method of claim 5, wherein the controller providing audio description of the coaching point occurs in at least one of before, during, and after execution of the coaching point.

7. The method of claim 1, further comprising the controller analyzing machine positioning and environmental conditions before and during execution of the coaching point.

8. The method of claim 7, wherein the controller analyzing machine positioning and environmental conditions before and during execution of the coaching point further comprises the controller analyzing at least one of machine stability, ground inclination, machine park brake condition, machine location, machine positioning, and object and person detection.

9. The method of claim 8, further comprising the controller proceeding with execution of the coaching point if no persons and no other machines are detected within a predetermined area around the machine by a perception system of the machine.

10. The method of claim 8, further comprising the controller proceeding with execution of the coaching point if the machine is located within a predetermined training area.

11. The method of claim 8, further comprising the controller suspending execution of the coaching point if the machine is not located within a predetermined training area.

12. The method of claim 8, further comprising the controller receiving information from other machines within a predetermined area around the machine.

13. The method of claim 2, further comprising the controller providing an automated demonstration of an actual action in accordance with the actual data before manipulating the machine to execute the coaching point according to the predetermined method.

14. The method of claim 1, wherein the predetermined method is an ideal operating method, and further comprising the controller providing an automated demonstration of a non-ideal operating method before manipulating the machine to execute the coaching point according to the predetermined method.

15. The method of claim 1, further comprising the controller providing instructions to maneuver the machine into an initial position before manipulating the machine to execute the coaching point according to the predetermined method.

16. The method of claim 1, further comprising the controller receiving input to enable a training mode and start monitoring performance of the operator.

17. The method of claim 1, further comprising the controller ceasing execution of the coaching point upon receipt of operator input.

18. The method of claim 1, further comprising the controller requiring input from a manager of the operator in order to approve execution of the coaching point by the controller.

19. A non-transitory computer readable storage medium having stored thereon computer-executable instructions which when executed by a computer coaches an operator of an earthmoving machine, the non-transitory computer-executable instructions comprising instructions for:
determining a type of operation being performed by the machine;
presenting a list of coaching points based on the type of operation being performed;
receiving input from the operator to execute a coaching point;
accessing memory to retrieve a predetermined method for executing the coaching point; and
controlling the machine to execute the coaching point according to the predetermined method.

20. The non-transitory computer readable storage medium of claim 19, further comprising instructions for providing audio description in at least one of before, during, and after execution of the coaching point, the audio description describing the predetermined method for executing the coaching point.

21. The non-transitory computer readable storage medium of claim 19, further comprising instructions for analyzing machine positioning and environmental conditions before and during execution of the coaching point.

22. The non-transitory computer readable storage medium of claim 19, further comprising instructions for receiving information from other machines within a predetermined area around the machine.

23. The non-transitory computer readable storage medium of claim 19, further comprising instructions for providing an automated demonstration of an actual action in accordance with actual data before controlling the machine to execute the coaching point according to the predetermined method.

24. A system for coaching an operator of an earthmoving machine, comprising:
an actuator of the machine;
an operator input/output device; and
a controller operatively connected to the operator input/output device and the actuator, the controller being configured to:
provide a coaching point to the operator,
receive input from the operator via the operator input/output device to execute the coaching point,
access memory to retrieve a predetermined method for executing the coaching point, and
send signals to the actuator according to the predetermined method for executing the coaching point.

25. The system of claim 24, wherein the controller is further configured to detect a type of operation being performed on the machine by the operator.

26. The system of claim 25, wherein the controller is further configured to compare actual data to expected data for the type of operation being performed, and provide a coaching point based on the comparison of actual data to expected data.

27. The system of claim 24, further comprising at least one of a plurality of sensors, a positioning system, a perception system, and a communications system.

28. The system of claim 24, wherein the actuator includes at least one of a power source, a transmission system, and a hydraulic system.

29. The system of claim 24, wherein the controller is further configured to provide audio description of the coaching point.

30. The system of claim 24, further comprising a perception system, and wherein the controller is further configured to proceed with execution of the coaching point if no persons and no other machines are detected within a predetermined area around the machine by the perception system.

31. The system of claim 24, further comprising a communications system, and wherein the controller is further configured to receive information from other machines within a predetermined area around the machine via the communications system.

32. The system of claim 24, wherein the controller is further configured to provide an automated demonstration of an actual action in accordance with actual data before manipulating execution of the coaching point according to the predetermined method.

33. The system of claim 24, wherein the controller is further configured to provide instructions to maneuver the machine into an initial position before execution of the coaching point according to the predetermined method.

34. The system of claim 24, wherein the controller is further configured to receive input to enable a training mode and start monitoring performance of the operator.

35. The system of claim 24, wherein the controller is further configured to cease execution of the coaching point upon receipt of operator input.

36. The system of claim 24, wherein the controller is further configured to require input from a manager of the operator in order to approve execution of the coaching point by the controller.
